(19) United States
(12) Patent Application Publication
(10) Pub. No.: US 2017/0171547 A1
(43) Pub. Date: Jun. 15, 2017

(54) METHOD FOR CONTROLLING DATA RATE OF MOTION VIDEO AND ELECTRONIC APPARATUS

(71) Applicants: Le Holdings (Beijing) Co., Ltd., Beijing (CN); LeCloud Computing Co., Ltd., Beijing (CN)

(72) Inventors: Chao Lv, Beijing (CN); Wei Wei, Beijing (CN); Maosheng Bai, Beijing (CN)

(21) Appl. No.: 15/247,464

(22) Filed: Aug. 25, 2016

Related U.S. Application Data
(63) Continuation of application No. PCT/CN2016/088714, filed on Jul. 5, 2016.

(30) Foreign Application Priority Data
Dec. 11, 2015 (CN) 201510921135.6

(51) Int. Cl. H04N 19/139; H04N 19/176; H04N 19/159; H04N 19/124; H04N 19/132

(52) U.S. Cl. CPC H04N 19/139; H04N 19/124; H04N 19/132; H04N 19/159; H04N 19/176

(57) ABSTRACT

Embodiments of the disclosure provide a method for controlling data rate of motion video and an electronic apparatus for the same. The method includes: downsampling the motion video and performing a traversal for each encoded macroblock in a currently downsampling frame; determining whether the encoded macroblock is a non-motion region encoded macroblock; and adjusting data rate of the non-motion region encoded macroblock, if the encoded macroblock is determined to be the non-motion region encoded macroblock. Thereby, the quality of live video in sport program is improved, therefore providing better watching experience for the user.

### CROSS REFERENCE TO RELATED APPLICATIONS

This application is a continuation of International Application No. PCT/CN2016/088714, filed on Jul. 5, 2016, which is based upon and claims priority to Chinese Patent Application No. 201510921135.6, filed on Dec. 11, 2015, the entire contents of which are incorporated herein by reference.

### TECHNICAL FIELD

The present disclosure relates to a field of video, particular to a method for controlling data rate of motion video and an electronic apparatus for the same.

### BACKGROUND

With the development of sport network video technology, more people choose to watch sport program on the Internet. Many people watch video simultaneously, especially NBA and other popular games to ensure the fluency of the sport live video, the setting of the bit rate for the live video is strictly required. However, the sport live video usually has an image with vigorous exercise such that the coding quality of the sport live video is lower than that of a standard video under the condition of same bit rate. Especially, when the scene having vigorous exercise is shown in the video, the image of frame may be blurred.

Therefore, a method for controlling data rate of motion video is urgently requested.

### SUMMARY

The disclosure provides a method for controlling data rate of motion video and an apparatus for the same. The method is for solving the disadvantage in the video having an image with strenuous exercise such the blur of the image, so as to achieve good quality of live video when the live video is played under lower data rate. Embodiments of the disclosure also provide an apparatus for controlling data rate of motion video.

To solve the aforementioned problem, embodiments of the disclosure provide a method for controlling data rate of motion video, including:

downsampling the motion video and performing a traversal for each encoded macroblock in a currently downsampling frame;

determining whether the encoded macroblock is a non-motion region encoded macroblock; and

adjusting data rate of the non-motion region encoded macroblock, if the encoded macroblock is determined to be the non-motion region encoded macroblock.

To solve the aforementioned problem, embodiments of the present disclosure provide a non-volatile computer storage medium. The computer storage medium stores computer-executable instructions, and the computer-executable instructions can carry out the method for controlling data rate of motion video in any one of the embodiments.

To solve the aforementioned problem, embodiments of the disclosure provide an electronic apparatus for controlling data rate of motion video, including: at least one processor; and a memory, wherein the memory is for storing one or more instructions executable by the processor, the processor is for calling the instructions stored in the memory to execute the method for controlling data rate of motion video in any one of the embodiments.

Compared to the conventional technique, the disclosure can achieve the following technical effect: by downsampling the current video frame and pre-analyzing the video frame according to the result of the downsampling, the characteristic of the non-motion region is obtained, that is, the non-motion region motion vector and the non-motion region mean inter frame cost, for determining whether each encoded macroblock in the video frame is non-motion region according to the characteristic of the non-motion region; thereby, the data rate is adjusted to improve the quality of live video in sport program, therefore providing better watching experience for the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a technique flow chart of an embodiment of the disclosure;

FIG. 2 is a technique flow chart of another embodiment of the disclosure;

FIG. 3 is a technique flow chart of another embodiment of the disclosure;

FIG. 4 is a schematic view of a device of another embodiment of the disclosure; and

FIG. 5 is a schematic view of an electronic apparatus of another embodiment of the disclosure.

### DETAILED DESCRIPTION

In the following detailed description, for purposes of explanation, numerous specific details are set forth in order to provide a thorough understanding of the disclosed embodiments. The main idea of the present disclosure is that: downsampling the motion video and performing a traversal for each encoded macroblock in a currently downsampling frame; determining whether the encoded macroblock is a non-motion region encoded macroblock; and adjusting data rate of the non-motion region encoded macroblock, if the encoded macroblock is determined to be the non-motion region encoded macroblock.

In a conventional configuration, a computer apparatus includes one or more central processing units (CPU), an input/output interface, a network interface and a memory.

The memory may include read only memory (ROM), random access memory (RAM) and/or nonvolatile memory, such as read only memory (ROM) and flash memory (flash RAM). The memory is an exemplary computer readable storage device.

The computer readable storage device may include volatile and non-volatile, removable and non-removable media may be made in any method or technology to achieve information storage. Information can be computer readable instructions, data structures, program modules or other data. Examples of computer readable storage device include, but are not limited to phase change memory (the PRAM), static random access memory (SRAM), dynamic random access memory (DRAM), other types of random access memory (RAM), read-only memory (ROM), electrically erasable programmable read-only memory (EEPROM), flash memory or other memory technology, CD-ROM read-only memory (CD-ROM), digital versatile disc (DVD) or other optical storage, magnetic tape cassette, magnetic disk storage or other magnetic tape storage devices, or any other magnetic non-transmission medium, it may be used to store the information can be computing device access. Defined in accordance with this article, a computer-readable medium excluding non staging computer-readable media (transitory media), such as a modulated data signal and the carrier.

As in the specification and claims which uses some words to refer to particular components. Skilled in the art will appreciate, manufacturers may use different terms to refer to the same component. This specification and claims are not to differences in the name as a way to distinguish between the components, but with differences in the functional components as a criterion to distinguish. As mentioned throughout the specification and claims, in which the “include” as an open-ended term, it should be interpreted to mean the term “include but not limited to”. The term “Substantially” means within the acceptable error range, those skilled in the art to solve the problem within a certain error range, substantially achieve the technical effect. Furthermore, “coupled” or “electrically connected” as used in this contain any direct or indirect electrical coupling means. Therefore, if the text is described a first device is coupled to a second device, said first means represents directly electrically coupled to said second means, or by other means or indirectly coupled to the means electrically coupled connected to the second device. Instructions subsequent description of the preferred embodiments of the present application, then the instructions are based on the general principles described in the present application for the purpose, not intended to limit the scope of the present application. When the scope of the present application, as the appended claims and their equivalents.

It is further noted that the term “comprising”, “including” or any other variation thereof, are intended to cover a non-exclusive inclusion, such that a series of factors including the process, method, product or system includes not only those elements, but also include other elements not expressly listed or further comprising for such process, method, product or inherent in the system elements. In the absence of more restrictive, by the statement “includes a” defining elements, does not exclude the existence of non-mentioned identical elements in the process include the elements, methods, goods or system.

Those skilled in the art understand that B frame is bi-directional predictive coding frame, P frame is forward predictive coding frame. Thus, any illustration for the type of frame will be omitted hereafter.

### 1^{st} Embodiment

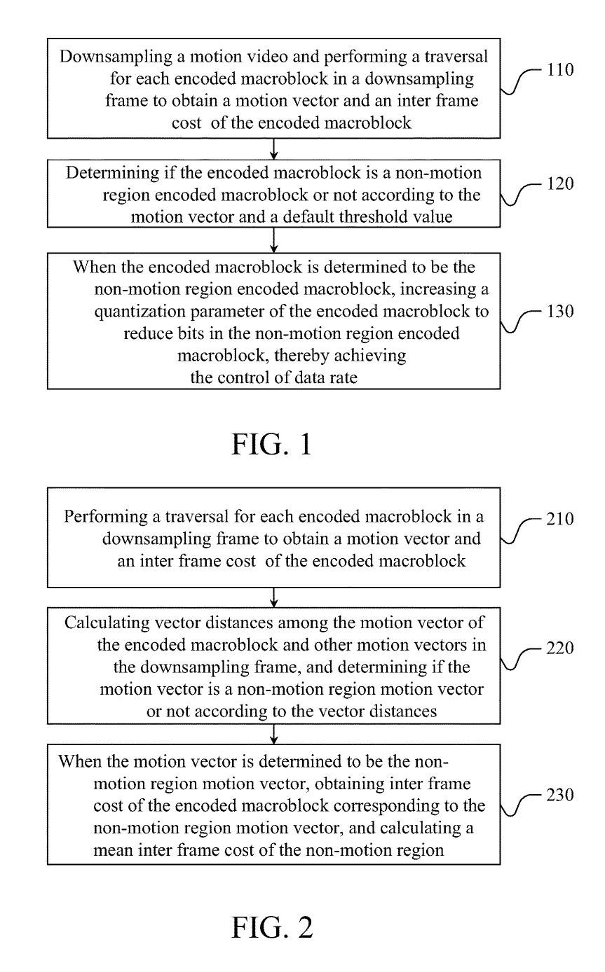

FIG. 1 is a technique flow chart of an embodiment of the present disclosure. In this embodiment of the present disclosure, a method is provided for controlling the data rate of a motion video, which mainly includes two steps:

step 110: downsampling the motion video and performing a traversal for each encoded macroblock in a currently downsampling frame, then obtaining a motion vector and an inter frame cost of the encoded macroblock;

step 120: determining whether the encoded macroblock is a non-motion region encoded macroblock according to the motion vector and a default threshold value for distance;

specifically, calculating a distance between the motion vector of the encoded macroblock and the non-motion region motion vector. When the distance is smaller than the default threshold value, determining the encoded macroblock is the non-motion region encoded macroblock. Wherein, the non-motion region motion vector is obtained by pre-analyzing the downsampling frame.

A motion vector is determined by x-direction and y-direction. Suppose a motion vector is defined by MV (x, y), there is a distance (dist) between any other motion vector MV₀ (x₀, y₀) and MV (x, y), and the distance is calculated by the following formula:

dist=|x−x₀|+|y−y₀|

specifically, the default threshold value is determined by the type of the downsampling frame, the inter frame cost and a mean inter frame cost of the non-motion region.

the default threshold value is equal to a, if the downsampling frame is at P frame, and an inter frame cost of the downsampling frame is smaller than a mean inter frame cost of the non-motion region; that is, when the distance between the motion vector of one encoded macroblock and the non-motion region motion vector is smaller than a, the one encoded macroblock is determined to be non-motion region encoded macroblock;

the default threshold value is equal to b, if the downsampling frame is at B frame, and the inter frame cost is smaller than the mean inter frame cost of the non-motion region; that is, when the distance between the motion vectors of one encoded macroblock and non-motion region encoded macroblock is smaller than b, the one encoded macroblock is determined to be non-motion region encoded macroblock;

the default threshold value is equal to c, if the downsampling frame is at B frame, and the inter frame cost is smaller than twice of the mean inter frame cost of the non-motion region; that is, when the distance between the motion vectors of one encoded macroblock and non-motion region encoded macroblock is smaller than c, the one encoded macroblock is determined to be non-motion region encoded macroblock;

wherein, a, b, c are empirical values, generally {a,b,c}={2,5,4}.

The aforementioned values selected to be the default threshold value is obtained by experiment, but the default threshold value in this embodiment is not limited thereto.

Step 130: adjusting an increment of a quantization parameter according to the type of the downsampling frame, and reducing a bit number for encoding in the non-motion region to adjust the data rate according to the increment of the quantization parameter of the encoded macroblock.

Generally, the non-motion region in the video is a background in which the user is not interested. Thus, the coded bit in the background can be reduced, and those coded bit can be allocated to another region in which the user is really interested, and thereby the quality of live video is improved.

Specifically, the data rate mainly controlled by adjusting the value of the quantization parameter, and the quantization parameter corresponds to the quantization step size one by one. For different coding standards, each quantization parameter has a corresponding relationship to the quantization step size, and the illustration is omitted hereafter. Smaller quantization parameter ensures that there are more bits used in the code. On the contrary, enlarging the quantization parameter reduces the bits used in the code. Thus, in this embodiment of the disclosure, the encoded macroblock belongs to the non-motion region encoded macroblock so as to enlarge the quantization parameter of the encoded macroblock to reduce the bits for coding in the non-motion region encoded macroblock, and thereby more bits are saved to focus on more coding in the motion region encoded macroblock.

For example, according to the type of the downsampling frame, the increment of the quantization parameter is adjusted to cause the following results:

if the downsampling frame is at P frame and the encoded macroblock belongs to the non-motion region encoded macroblock, the quantization parameter of the encoded macroblock is equal to 1; and

if the downsampling frame is at B frame and the encoded macroblock belongs to the non-motion region encoded macroblock, the quantization parameter of the encoded macroblock is equal to 2.

Of course, it should be understood that the aforementioned increment of the quantization parameter is only exemplary, and the embodiments of the disclosure are not limited thereto.

In this embodiment, each encoded macroblock in the video frame is determined to be the motion region or the non-motion region according to the characteristic of the non-motion region. By reducing the bits allocated to the background of the motion video which gives less influence on the subjective quality, most of the bits are allocated to the motion part of the video which gives more influence on the subjective quality, and thereby the quality of the video is improved to provide better watching experience for the user.

The characteristic of the non-motion region is obtained by pre-analyzing the downsampling frame. A specific method for pre-analyzing the downsampling frame is further illustrated in the second embodiment.

### 2^{nd} Embodiment

FIG. 2 is a technique flow chart of another embodiment of the present disclosure. In this embodiment of the present disclosure, a method is provided for controlling the data rate of the motion video, and the downsampling frame is pre-analyzed by the following steps:

step 210: performing a traversal for each encoded macroblock in the downsampling frame, and obtaining needed motion vector and inter frame cost of the encoded macroblock;

step 220: calculating the distances among the motion vector of the encoded macroblock and the other motion vectors in the downsampling frame, and determining whether the motion vector is a non-motion region motion vector according to the distances among the motion vectors.

If calculating the distances among said motion vector and the other motion vectors, the distance formula in the first embodiment is adapted as a specific formula hereafter.

If the vector distance is smaller than the default threshold value, collecting statistics for the quantity N of the other motion vectors;

if the motion vector satisfies the following conditions a and b, determining the motion vector is the non-motion region motion vector;

condition a: a preset ratio of the encoded macroblock corresponding to the quantity N of the other motion vectors in all encoded macroblocks of the downsampling frame;

condition b: among all motion vectors in the downsampling frame, the vector distances among additional motion vectors and a quantity M of the motion vectors are not in the range of the default threshold value, wherein M>N.

The non-motion region motion vector is the reference condition for determining whether the encoded macroblock is the non-motion region. If all motion vectors in the current video frame do not satisfy the aforementioned two conditions, it is determined that there is no non-motion region (background) in the current frame such that it is unnecessary to control the data rate.

In this embodiment of the disclosure, according to the experience, the distance is equal to 3, and the preset ratio is 30%, but the embodiment of the disclosure is not limited thereto.

Step 230: if the motion vector is determined to be the non-motion region motion vector, obtaining the inter frame cost of the non-motion region motion vector corresponding to the encoded macroblock and calculating mean inter frame cost of the non-motion region.

Each non-motion region motion vector corresponds to a non-motion region encoded macroblock. The inter frame cost of each encoded macroblock is obtained in the step 210. Thus, in this step, the mean inter frame cost of the non-motion region is calculated only by reading the inter frame cost corresponding to the non-motion region encoded macroblock and according to the value of obtained inter frame cost.

The mean inter frame cost of the non-motion region is one of characteristic of the non-motion region for one of reference data when the encoded macroblock in the current frame is determined.

In this embodiment, by downsampling the current video frame and pre-analyzing the video frame according to the result of the downsampling, the characteristic of the non-motion region is obtained, that is, the non-motion region motion vector and the non-motion region mean inter frame cost, for determining whether each encoded macroblock in the video frame is non-motion region according to the characteristic of the non-motion region; thereby, the data rate is adjusted to improve the quality of live video in sport program, therefore providing better watching experience for the user.

### 3^{rd} Embodiment

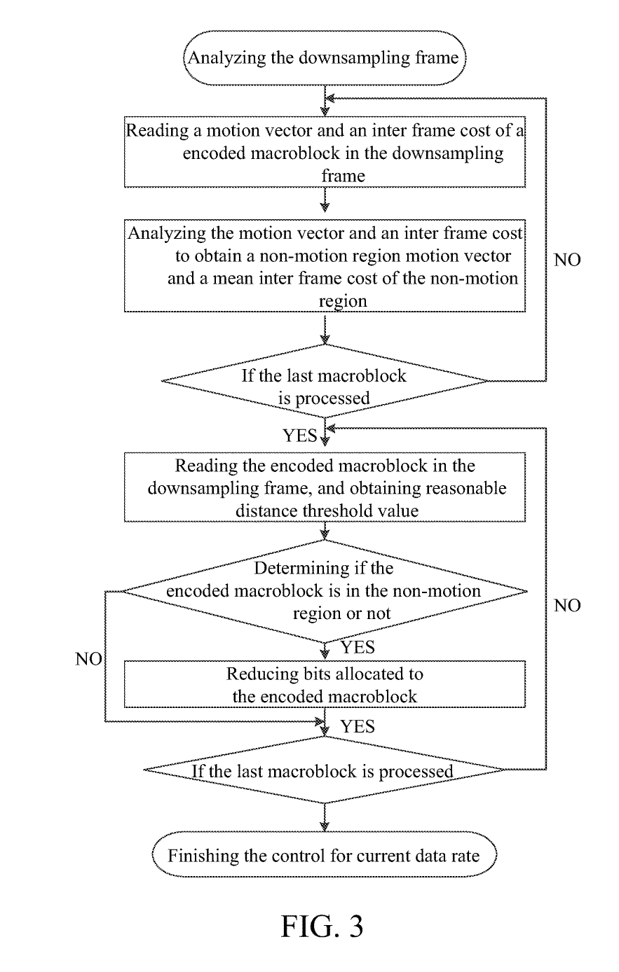

FIG. 3 is a technique flow chart of another embodiment of the present disclosure. The following illustration for the embodiment of the disclosure is described combined with FIG. 3. In the embodiment of the disclosure, when the data rate of the motion video is controlled, at first, the downsampling frame of the motion video is analyzed. The analysis of the downsampling frame is actually the analysis of the motion vector and the inter frame cost of each encoded macroblock.

In the inter frame prediction coding, since the scenery in motional images close to the frame correspond to each other. Thus, the motional image can be divided into several blocks or macroblocks, and try to find the position where each block or macroblock is located in the adjacent frame of image, and obtain a relative shift in the space between positions of the block and the frame of image. The obtained relative shift is the motion vector.

After the motion vector and the inter frame cost are obtained, the background region in the downsampling frame, that is the non-motion region, is analyzed, so as to obtain the characteristics of the motion vector and the inter frame cost of the non-motion region, for the reference to determining whether the encoded macroblock in the downsampling frame is motion region or non-motion region, and thereby the data rate is adjusted. The pre-analysis in the embodiment of the disclosure needs to perform a traversal for each encoded macroblock to completely obtain the characteristic of the non-motion region to achieve correct determination for the encoded macroblock.

After the last encoded macroblock in the downsampling frame is analyzed, the information of each encoded macroblock in the downsampling frame is read again, and the encoded macroblock is matched with reasonable distance threshold value according to the information, for determining whether the encoded macroblock is motion region.

When the encoded macroblock is determined to be non-motion region, the bits allocated to this encoded macroblock is reduced. When the last macroblock in the downsampling frame is processed, the control of data rate in this frame is finished.

### 4^{th} Embodiment

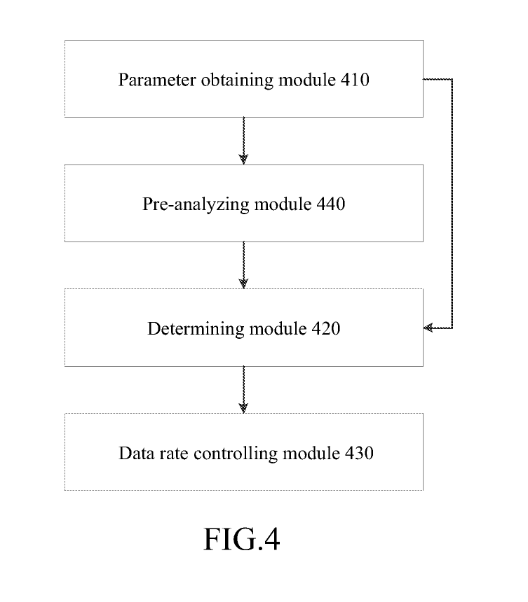

FIG. 4 is a schematic view of device of another embodiment of the present disclosure. The embodiment of the disclosure provides a device for controlling data rate of motion video, and the device mainly includes the following modules: a parameter obtaining module 410, a determining module 420, a data rate controlling module 430, and a pre-analyzing module 440.

The parameter obtaining module 410 is adapted for downsampling the motion video and performing the traversal for each encoded macroblock in the downsampling frame;

the determining module 420 is adapted for determining whether the encoded macroblock is a non-motion region encoded macroblock;

the data rate controlling module 430 is adapted for adjusting data rate of the non-motion region encoded macroblock if the encoded macroblock is determined to be the non-motion region encoded macroblock.

The device further includes a pre-analyzing module 440 adapted for: calculating vector distances among the motion vector of the encoded macroblock and other motion vectors in the downsampling frame;

if the vector distance is smaller than the default threshold value, collecting statistics for a quantity N of the other motion vectors.

if the motion vector satisfies the following conditions a and b, determining the motion vector is the non-motion region motion vector.

condition a: a preset ratio of the encoded macroblock corresponding to the quantity N of the other motion vectors in all encoded macroblocks of the downsampling frame; and

condition b: among all motion vectors in the downsampling frame, the vector distances among additional motion vectors and a quantity M of the motion vectors are not in range of the default threshold value, wherein M>N.

The determining module 420 is further adapted for: calculating the distance between the motion vector of the encoded macroblock and the non-motion region motion vector. If the distance is smaller than the default threshold value, determining the encoded macroblock is the non-motion region encoded macroblock.

The determining module 420 is further adapted for: calculating the default threshold value by following steps:

if the downsampling frame is at P frame, and an inter frame cost of the downsampling frame is smaller than a mean inter frame cost of a non-motion region, the default threshold value is equal to a;

if the downsampling frame is at B frame, and the inter frame cost is smaller than the mean inter frame cost of the non-motion region, the default threshold value is equal to b;

if the downsampling frame is at B frame, and the inter frame cost is smaller than twice of the mean inter frame cost of the non-motion region, the default threshold value is equal to c;

wherein the mean inter frame cost of the non-motion region is calculated according to the inter frame cost of the motion vector in the non-motion region corresponding to the non-motion region encoded macroblock, and a, b, c are empirical values.

The data rate controlling module 430 is specifically adapted for: adjusting the increment of the quantization parameter according to the type of the downsampling frame, and reducing bit rate in the non-motion region to adjust data rate according to the increment of the quantization parameter of the encoded macroblock. The device shown in FIG. 4 can implement the method illustrated in the embodiments of FIGS. 1-3. Enabled theory and technical effect can be referred to the embodiments of FIGS. 1-3, and such illustration is omitted hereafter.

The device described above embodiments are merely exemplary, and wherein said means separating member as described may or may not be physically separated, as part of the display unit may be or may not be physical units, That may be at one place, or it can be distributed to multiple network elements. You can select part or all of the modules to achieve the purpose of implementation of the program according to the embodiment of the actual needs. Those of ordinary skill in the case without paying any creative work that can be understood and implemented.

### 5^{th} Embodiment

A fifth embodiment is the present disclosure provides a non-volatile computer storage medium. The computer storage medium stores computer-executable instructions, and the computer-executable instructions can carry out the method for controlling data rate of motion video in any one of the embodiments.

### 6^{th} Embodiment

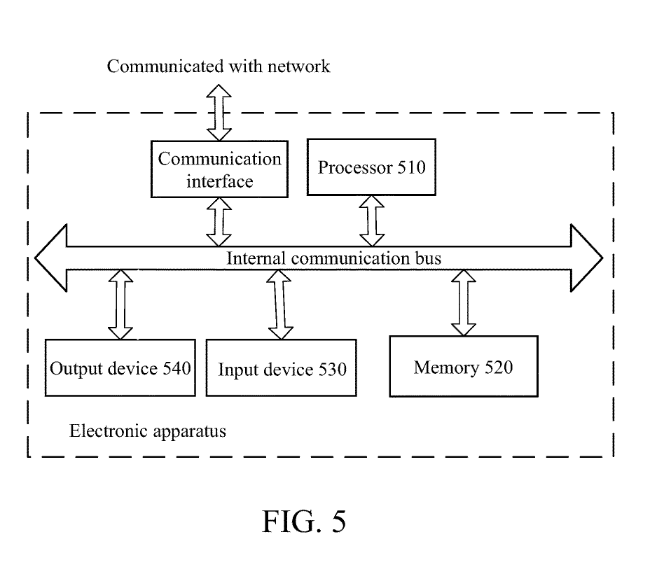

FIG. 5 is a schematic view of apparatus another embodiment of the present disclosure. In this embodiment of the disclosure, an electronic apparatus for controlling data rate of motion video is provided. As shown in FIG. 5, the electronic apparatus mainly includes:

one or more processors 510 and a memory 520, and the processor 510 is one in quantity in FIG. 5.

The electronic apparatus for controlling data rate of motion video can include: an input device 530 and an output device 540.

The processor 510, the memory 520, the input device 530 and the output device 540 can be connected to each other via a bus or other members for electrical connection. In FIG. 5, they are connected to each other via the bus in this embodiment.

The memory 520 is one kind of non-volatile computer-readable storage mediums applicable to store non-volatile software programs, non-volatile computer-executable programs and modules. The processor 510 executes function applications and data processing of the server by running the non-volatile software programs, the non-volatile computer-executable programs and modules stored in the memory 520, and thereby the methods for controlling data rate of motion video in the aforementioned embodiments are achievable.

The memory 520 can include a program storage area and a data storage area, wherein the program storage area can store an operating system and at least one application program required for a function; the data storage area can store the data created according to the usage of the device for video switch. Furthermore, the memory 520 can include a high speed random-access memory, and further include a non-volatile memory such as at least one disk storage member, at least one flash memory member and other non-volatile solid state storage member. In some embodiments, the memory 520 can have a remote connection with the processor 510, and such memory can be connected to the device for controlling data rate of motion video by a network. The aforementioned network includes, but not limited to, internet, intranet, local area network, mobile communication network and combination thereof.

The input device 530 can receive digital or character information, and generate a key signal input corresponding to the user setting and the function control of the device for controlling data rate of motion video. The output device 540 can include a displaying unit such as screen.

The technical feature of the terminal apparatus, the function of each functional module and the relationships among the functional modules correspond to the embodiments described in FIGS. 1 to 5. Any deficiencies in the illustration can be referred to the aforementioned embodiments.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The aforementioned embodiments are described for the purpose of explanation. The element for displaying can be a physical element or mot; that is, the element for displaying can be located on a specific position or distrusted among plural network units. Many modifications and variations are possible in view of part or all of the above teachings, to thereby enable others skilled in the art to best utilize the disclosure and various embodiments with various modifications as are suited to the particular use contemplated.

Through the above described embodiment, those skilled in the art can understand that the present disclosure may be implemented by software necessary hardware platform to achieve, of course, can all be implemented by hardware. Based on this understanding, the technical aspect of the present disclosure, background technology to contribute all or part may be embodied in the form of a software product, the computer software product may be stored in a storage medium, such as ROM/RAM, disk, CD-ROM, including several instructions to instruct a computer device (a personal computer, server, or network equipment) to perform various embodiments of the disclosure, or some portion of the method according to an embodiment.

Although described above with reference to FIG been described in accordance with various embodiments of the present disclosure, those skilled in the art would understand, the various embodiments of the present disclosure is made, may also departing from the present disclosure is not based on make a variety of improvements. Accordingly, the scope of the disclosure should be determined by the appended claims contents of the book claims.

What is claimed is:

1. A method for controlling data rate of a motion video, applicable to terminal, comprising:
downsampling the motion video and performing a traversal for each encoded macroblock in a currently downsampling frame;
determining whether the encoded macroblock is a non-motion region encoded macroblock; and
adjusting data rate of the non-motion region encoded macroblock, if the encoded macroblock is determined to be the non-motion region encoded macroblock.

2. The method according to claim 1, wherein the determining whether the encoded macroblock is the non-motion region encoded macroblock comprises:
calculating a distance between a motion vector of the encoded macroblock and a non-motion region motion vector, if the distance is smaller than a default threshold value, determining the encoded macroblock is the non-motion region encoded macroblock.

3. The method according to claim 2, wherein the determining the motion vector is a non-motion region motion vector comprises:
calculating vector distances among the motion vector of the encoded macroblock and other motion vectors in the downsampling frame;
collecting statistics for a quantity N of the other motion vectors, if the vector distance is smaller than the default threshold value; and
determining the motion vector is the non-motion region motion vector, if the motion vector satisfies the following conditions a and b;
condition a: a preset ratio of the encoded macroblock corresponding to the quantity N of the other motion vectors in all encoded macroblocks of the downsampling frame;
condition b: among all motion vectors in the downsampling frame, the vector distances among additional motion vector and a quantity M of the motion vectors are not in range of the default threshold value, wherein M>N.

4. The method according to claim 2, wherein the default threshold value is calculated by:
the default threshold value is equal to a, if the downsampling frame is at P frame, and an inter frame cost of the downsampling frame is smaller than a mean inter frame cost of the non-motion region;
the default threshold value is equal to b, if the downsampling frame is at B frame, and the inter frame cost is smaller than the mean inter frame cost of the non-motion region;
the default threshold value is equal to c, if the downsampling frame is at B frame, and the inter frame cost is smaller than twice of the mean inter frame cost of the non-motion region;
wherein the mean inter frame cost of the non-motion region is calculated according to the inter frame cost of the non-motion region encoded macroblock corresponding to the non-motion region motion vector; and a, b, c are empirical values.

5. The method according to claim 1, wherein the adjusting data rate of the encoded macroblock comprises:
adjusting an increment of a quantization parameter according to type of the downsampling frame, and reducing a bit number for encoding in the non-motion region to adjust data rate according to the increment of the quantization parameter of the encoded macroblock.

6. A non-volatile computer storage medium storing a computer-executable instruction, and the computer-executable instruction being for:
downsampling the motion video and performing a traversal for each encoded macroblock in a currently downsampling frame;
determining whether the encoded macroblock is a non-motion region encoded macroblock; and
adjusting data rate of the non-motion region encoded macroblock, if the encoded macroblock is determined to be the non-motion region encoded macroblock.

7. The non-volatile computer storage medium according to claim 6, wherein the determining whether the encoded macroblock is the non-motion region encoded macroblock comprises:
calculating a distance between a motion vector of the encoded macroblock and a non-motion region motion vector, if the distance is smaller than a default threshold value, determining the encoded macroblock is the non-motion region encoded macroblock.

8. The non-volatile computer storage medium according to claim 7, wherein the determining the motion vector is a non-motion region motion vector comprises:
calculating vector distances among the motion vector of the encoded macroblock and other motion vectors in the downsampling frame;
collecting statistics for a quantity N of the other motion vectors, if the vector distance is smaller than the default threshold value; and
determining the motion vector is the non-motion region motion vector, if the motion vector satisfies the following conditions a and b;
condition a: a preset ratio of the encoded macroblock corresponding to the quantity N of the other motion vectors in all encoded macroblocks of the downsampling frame;
condition b: among all motion vectors in the downsampling frame, the vector distances among additional motion vector and a quantity M of the motion vectors are not in range of the default threshold value, wherein M>N.

9. The non-volatile computer storage medium according to claim 7 wherein the computer-executable instruction is for calculating the default threshold value by:
the default threshold value is equal to a, if the downsampling frame is at P frame, and an inter frame cost of the downsampling frame is smaller than a mean inter frame cost of the non-motion region;
the default threshold value is equal to b, if the downsampling frame is at B frame, and the inter frame cost is smaller than the mean inter frame cost of the non-motion region;
the default threshold value is equal to c, if the downsampling frame is at B frame, and the inter frame cost is smaller than twice of the mean inter frame cost of the non-motion region;
wherein the mean inter frame cost of the non-motion region is calculated according to the inter frame cost of the non-motion region encoded macroblock corresponding to the non-motion region motion vector; and a, b, c are empirical values.

10. The non-volatile computer storage medium according to claim 6, wherein the adjusting data rate of the encoded macroblock comprises:
adjusting an increment of a quantization parameter according to type of the downsampling frame, and reducing a bit number for encoding in the non-motion region to adjust data rate according to the increment of the quantization parameter of the encoded macroblock.

11. An electronic apparatus, comprising:
at least one processor; and
a memory communicatively connected to the at least one processor, wherein the memory stores an instruction executable by the at least one processor, the at least one processor is for calling the instruction to execute a method comprising:
downsampling the motion video and performing a traversal for each encoded macroblock in a currently downsampling frame;
determining whether the encoded macroblock is a non-motion region encoded macroblock; and
adjusting data rate of the non-motion region encoded macroblock, if the encoded macroblock is determined to be the non-motion region encoded macroblock.

12. The electronic apparatus according to claim 11, wherein the determining whether the encoded macroblock is the non-motion region encoded macroblock comprises:
calculating a distance between a motion vector of the encoded macroblock and a non-motion region motion vector, if the distance is smaller than a default threshold value, determining the encoded macroblock is the non-motion region encoded macroblock.

13. The electronic apparatus according to claim 12, wherein the determining the motion vector is a non-motion region motion vector comprises:
calculating vector distances among the motion vector of the encoded macroblock and other motion vectors in the downsampling frame;
collecting statistics for a quantity N of the other motion vectors, if the vector distance is smaller than the default threshold value; and
determining the motion vector is the non-motion region motion vector, if the motion vector satisfies the following conditions a and b;
condition a: a preset ratio of the encoded macroblock corresponding to the quantity N of the other motion vectors in all encoded macroblocks of the downsampling frame;
condition b: among all motion vectors in the downsampling frame, the vector distances among additional motion vector and a quantity M of the motion vectors are not in range of the default threshold value, wherein M>N.

14. The electronic apparatus according to claim 12, wherein the instruction is for calculating the default threshold value by:
the default threshold value is equal to a, if the downsampling frame is at P frame, and an inter frame cost of the downsampling frame is smaller than a mean inter frame cost of the non-motion region;
the default threshold value is equal to b, if the downsampling frame is at B frame, and the inter frame cost is smaller than the mean inter frame cost of the non-motion region;
the default threshold value is equal to c, if the downsampling frame is at B frame, and the inter frame cost is smaller than twice of the mean inter frame cost of the non-motion region;
wherein the mean inter frame cost of the non-motion region is calculated according to the inter frame cost of the non-motion region encoded macroblock corresponding to the non-motion region motion vector; and a, b, c are empirical values.

15. The electronic apparatus according to claim 11, wherein the adjusting data rate of the encoded macroblock comprises:
adjusting an increment of a quantization parameter according to type of the downsampling frame, and reducing a bit number for encoding in the non-motion region to adjust data rate according to the increment of the quantization parameter of the encoded macroblock.
